(19) United States
(12) Patent Application Publication
(10) Pub. No.: US 2023/0075125 A1
(43) Pub. Date: Mar. 9, 2023

(54) ONLINE LICENSING PLATFORM COMPRISING PRE-AUTHORIZATION BLOCK, RATINGS OF ATHLETES' PLATFORM-RELATED ACTIVITIES, LINK TO VIEW AMATEUR ATHLETE ONLINE SOCIAL MEDIA POSTS, AND LIVE STREAMING

(71) Applicant: James E. BEECHAM, West Palm Beach, FL (US)

(72) Inventor: James E. BEECHAM, West Palm Beach, FL (US)

(21) Appl. No.: 17/825,917

(22) Filed: May 26, 2022

Related U.S. Application Data
(63) Continuation-in-part of application No. 17/470,193, filed on Sep. 9, 2021, now abandoned.
Application No. 17/470,193 is a continuation-in-part of application No. 17/582,875, filed on Jan. 24, 2022, now abandoned.

(51) Int. Cl. G06Q 30/02; H04N 21/2187

(52) U.S. Cl. CPC G06Q 30/0279; H04N 21/2187; G06Q 2220/18

(57) ABSTRACT

An online licensing platform connecting a fan with an amateur athlete and providing for a conveyance of money to an amateur athlete contemporaneous to conveyance of licensing rights to a fan, said platform further comprises platform links configured to provide access for a plurality of platform-registered fans to social media accounts of a plurality of platform-registered athletes. In a preferred embodiment, platform further comprising platform-linked fans invited to view live-streamed events on platform. Platform further comprises amateur-status-protective pre-authorization sign-up block to steps of registration, said steps continuation requiring that registering user first confirm by click having read notice. Said block/notice at least tends to reduce potential of loss of amateur status eligibility for registrant.

### CROSS-REFERENCE TO RELATED APPLICATION

The present invention is a continuation in part application to non-provisional application Ser. No. 17/470,193 filed 9 Sep. 2021 entitled ‘METHOD AND SYSTEM FOR SPORTS ATHLETE SELLING USE-OF-NAME LICENSE TO FAN TO ENABLE DISPLAY OF SAID ATHLETE NAME IN AD ENDORSEMENT OF TEAM SPIRITEDNESS OF SAID FAN ON SAID FAN SOCIAL MEDIA PAGE’ and to non-provisional application Ser. No. 17/582,875 filed 24 Jan. 2022 entitled ‘ONLINE LICENSING PLATFORM WITH ADDITIONAL FEATURES’, which publications are hereby incorporated in their entirety at least by reference.

### 1. Field of the Invention

The present invention generally relates to online licensing platform connecting a fan with an amateur athlete and providing for a conveyance of money to an amateur athlete contemporaneous to conveyance of licensing rights to a fan. More specifically, instant invention platform relates to pre-authorization block, fan-rating of athletes, platform link to allow fan to access athlete social media posts, and live streaming via platform comprising view to registered users of amateur sporting events and fan contests.

### BRIEF SUMMARY OF THE INVENTION

In a preferred embodiment, the present invention relates to a system and method for fans to connect online with amateur athletes and providing for a conveyance of money to an amateur athlete contemporaneous to conveyance of licensing rights to a fan (rights licensed comprise use of athlete name, image, likeness—known as NIL). In a preferred embodiment, said connecting allows fan to understand goals and thoughts of said amateur athletes, such as via platform wherein link to social media of athletes allows fan-user to see athlete's online postings. Optionally, said fan access informs decision of fan regarding fan purchase of license from athlete whose social media posts fan has perused via platform link.

In a preferred embodiment, instant invention comprises an online licensing platform allowing a fan to view ratings of athlete's activity on platform, said ratings applied by other platform-registered fans. In a preferred embodiment, said rating of athletes comprises fan assessment of quality of social media posts of athletes, responsiveness of athlete to fan request for video conference, and athletic performance rating by fans of athlete as seen via live streaming link of online licensing platform. Said ratings can be a factor in fan's selection of athlete for license purchase.

In a preferred embodiment, instant invention online licensing platform connects a fan with an amateur athlete and provides for a conveyance of money to an amateur athlete contemporaneous to conveyance of licensing rights to a fan. In a preferred embodiment, said platform uses, in registration and search functions, a plurality of county names.

In a preferred embodiment, said county names comprise locations which house schools attended by platform-registered high school student-athletes. Typically, such names of counties are specified by registering athlete as input from dropdown menu of counties in states which have laws allowing NIL license sale by high school athletes. Such county names comprise searchable aspect of platform-registered high school athletes. During search, such counties are specified as input from dropdown menu by searching fans to indicate the location of their searched-for athlete's school location. One benefit of use of county name is to simplify registration of large number of high school athletes, amalgamating for registration purposes a plurality of high schools in a single county.

In a preferred embodiment, said county names are typically used in conjunction with high school athletes (HSA) whose conference and school regulations allow NIL activities by these HSA while the athletes retain amateur status eligibility. In a preferred embodiment, said counties are in a plurality of states in USA wherein said respective state laws permit/have legalized NIL license-selling activity by high school athletes.

In a preferred embodiment, pre-registration block comprises notice programmed as compulsory to click response, a display to interrupt registration sign-up until block notice responded to by person attempting to register. In a preferred embodiment, said block, i.e., stoppage until response of further steps of sign-up, comprises a sequence which at least potentially safeguards amateur status of registering student-athlete.

In a preferred embodiment, registering athlete is required to click, designating having read said notice associated to said block of sign-up process. In preferred embodiment, athlete registration is prevented by said block from continuing until after athlete clicks certification of his or her having read the said notice, and further clicks to indicate his or her desire to continue steps of platform registration.

In a preferred embodiment, said notice provides a protective effect against athlete registering to platform and selling NIL licenses in contravention of state or local NIL-related regulations applicable to registering athlete. In a preferred embodiment, notice reads as follows—

Notice: No student-athlete should register herein until after the student-athlete first verifies he or she will not be disadvantaged by registration herein, such as by school or conference or other authorities ruling against student-athlete's amateur status or eligibility to participate in school sports.

In a preferred embodiment, such block against continuance of registration steps until after confirmation by user of his or her reading of said amateur-status-protective notice, said block is known herein as pre-authorization block. The word authorization is herein defined as a document giving permission to platform to represent a registering person as their selected category. In a preferred embodiment, the authorization given to platform comes from the registrant clicking one selection of ‘NIL-eligible college athlete’ or ‘NIL-eligible high school athlete’.

In preferred embodiment, the selection step which is typically presented to registering person after the block step response, the selection step is taken by platform as authorizing the platform to present said person as their selected persona, i.e., legitimate NIL-capable/eligible student athlete playing either college sports or high school sports.

As background, the term ‘NIL-eligible’ is herein defined as a student athlete who is able, within all applicable regulations of law and conference and school, to sell license for use of his or her name, image, or likeness and retain amateur status and eligibility. Such athletes, because they can sell NIL and remain within the rules and regulations determining eligibility for participation in amateur athletics, can register on instant invention platform without risk to amateur status.

In a preferred embodiment, a further pre-authorization block is applied on platform to registering person at time immediately preceding person uploading photo and/or video. In a preferred embodiment, said upload-associated block is a notice that requires person to click as documentation of his having read the notice which is associated to regulations regarding use of photo/video. The person, certifying his having read said notice, then clicks to continue or clicks to close. The authorization given platform by continuing is taken to be registering person allowing platform to present his/her photo/video as true representation of identity of registering person as a student athlete who is NIL-license-selling eligible as to content of photo/video versus specific regulations applicable to said student-athlete. In a preferred embodiment, the photo notice has following wording: ‘Before posting your photo: Some schools do not allow you to wear your uniform during NIL activities or show school facilities in the photo. Find out your school's policy first, before posting your photo’. In a preferred embodiment, the video notice has following wording: ‘Before posting your video: Some schools do not allow you to say trademarked school verbiage during NIL activities, such as posting a video of you saying the school's name or team name. Find out your school's policy first, before posting your video’.

In preferred embodiment, such programmed enforcement of registering athlete to confirm reading of photo/video upload-related notice, can increase likelihood athlete will read the notice and then check regulations and comply. Such checking by athlete of regulations can prevent athlete inadvertently violating school and/or conference regulations, and/or state law, a potentially protective measure for his or her amateur eligibility.

In a preferred embodiment, instant invention further comprises links to online licensing platform allowing a plurality of athlete online blogs and social media accounts to be accessed by electronic link and contemporaneously by a plurality of fans. Typically, such link connections allow said plurality of fans to choose among links for viewing posts and determining and identifying their respective favorite athletes. Typically, such viewing by fans enables fans to better understand student athlete goals and feelings and thoughts. Typically, via such better understanding, fans develop an improved basis for deciding which student athlete to support with fans' purchase of NIL licenses.

In a preferred embodiment, instant invention comprises registration of at least one high school student-athlete. In a preferred embodiment, a person wishing to be HSA registrant will view a platform notice comprising reference to legal status for HSA NIL licensing-selling activities, such as in various states in USA. As of the time of this writing, approximately nine of the fifty USA states have what experts consider to be finalized regulations supporting HSA participation in NIL.

In a preferred embodiment, instant invention comprises allowing a fan to view a recommendation by a first athlete regarding fan purchase of license from a second recommended athlete. Typically, said recommendation is allowed by first athlete inputting the identification number (ID #) of said second athlete he recommends. Input is onto online licensing platform in space provided to first athlete in his or her profile. Typically, a plurality of athlete ID #s can be input by said first athlete in such recommendations. In a preferred embodiment, such recommendations are by a first athlete of a specific school team, recommending a second athlete who is also on same school team. In a preferred embodiment, a chain of recommendations is allowed which can provide for a full roster of team members of a school team to recommend each other. For example, a first athlete can recommend three team members, and each of these can recommend three other team members, and so on. Typically, by several levels of such recommendations, the full team can be recommended to a plurality of fans, such as by inputting these team members' ID #s by teammates.

In a preferred embodiment, instant invention comprises registrants to view written terms of license agreement between fan and athlete as applicable to sale of licenses on the platform. Requirement by some schools specifying that NIL license agreements must be in writing, these requirements are at least partly satisfied by said platform notice and pre-agreement of registrants.

As background, many observers believe the state of implementation of NIL licensing selling by student-athletes in USA reached an inflection point with the 9-0 Supreme Court of the USA vote in the Alston case (21 Jun. 2021). Many observers believe that the unanimity of the vote by the justices, and the writings by the justices in their concurring opinions constitute strong indications, to the NCAA and other regulatory bodies of amateur sports, that the Constitution of the United States will likely be similarly interpreted as supporting NIL by courts in future cases if brought. Such analysis suggests school sports athletes could achieve pay for performance in amateur athletics, in a manner like the Olympics allowing professional athletes to participate as amateurs in the Olympics despite having a professional sports career away from the Olympics.

As background, observers view the attitude of the NCAA after the Alston decision as suggesting a likelihood that, absent a federal law, at least the near-term future of NIL licensing-selling by student-athletes will be based on a series of differing rules developed by several local jurisdictions and states. Such differing rules might be applied state to state, conference to conference, and school to school, rather than enforced from a national body or the federal government.

In a preferred embodiment, especially in view of the near-term likelihood of said differing rules within various jurisdictions, a series of safeguards are applied within instant invention to protect amateur athlete from inadvertent violation of rules of his school, conference, or state. In a preferred embodiment for example, on the home page of the website, a statement appears to the effect: ‘Offer void, where prohibited by law or in violation of school policy’.

In a preferred embodiment, pre-authorization block/notice alerts a person attempting to register within instant invention platform, such notice referencing the advisability of said person to personally verify such registration is within regulations for NIL license-selling by student-athlete as applicable to his or her situation. Typically, such block requires person to at least acknowledge having read notice before continuing.

As background, such requirements related to NIL can vary school to school. Often schools will post online their requirements. In a preferred embodiment, instant invention block/notice can optionally allow advice to be rendered to registering athlete to urge athlete to check online for such school-based specific requirements. In a preferred embodiment, block/notice coordinate to at least potentially reduce likelihood said registering person will upload photo and/or video which content is not in compliance to school regulations.

In a preferred embodiment, instant invention comprises at least one platform-linked reference to student athlete lack of funds. Typically, such reference can be a written discussion, a video presentation, a linked social media reference posted by athlete. Typically, such reference is viewable by fan. Typically, such reference provides fan a better understanding of student athlete registrant's sports-related goals and thoughts and feelings.

In a preferred embodiment, such better understanding provides a fan at least one basis by which to determine if fan, to support athlete, wishes to purchase a license from said athlete, i.e., to pay to use said athlete's name, image, or likeness. Typically, a plurality of licenses can be purchased contemporaneously by a plurality of fans from a plurality of registered student athletes via instant invention online license platform.

In a preferred embodiment, instant invention comprises search referencing fan finding profile within instant invention platform-linked data of at least one of college student athlete or high school student athlete. Typically, said search is instituted by registered fan. Typically, such search comprises fan selection from dropdown menu of at least one of state name, city name, county name.

In a preferred embodiment, instant invention comprises several levels of verification for identification of registered athlete as to being true person named in platform registration. In a preferred embodiment, instant invention informs fan users to exercise discretion on platform in dealing with a person purporting to be a named athlete. Where the posts comprise video of person who fan viewer recognizes as true named athlete, that is a level of confirmation.

In a further level of verification optionally used by instant invention, the coach of team can issue a statement listing ID #s of athlete registration on site as linked to true named athlete on coach's team. In a further level of verification optionally used by instant invention, the coach of the team can video the team assembled, and in that video each team member can speak and hold up sign to view, demonstrating their individual ID # to viewer of video. In a further level of verification optionally used by instant invention, the coach can sponsor a biometric registration of his team members. Such biometric data can be used by athlete in logging in at instant invention site. Fans can be made aware of such procedure's use as verification of athlete's identification on platform. In a preferred embodiment, the fan request via instant invention platform for video conference with instant invention registered athlete comprises at least potential for further identity verification directly by fan.

In a preferred embodiment, instant invention comprises at least one of: progressive web application with instructions for user to apply a procedure whereby user can electronically place icon of said app on user's cell phone home page, and/or at least one URL for video located and linkable in view of user of home page, and/or configuration whereby video conference can be requested by platform-registered fan with platform-registered individual who self-identified as NIL-eligible student athlete. Typically, said video conference request is viewable on platform by athlete, such as to identity or claimed name of requesting fan. Typically, said athlete offered video conference request by said identified fan can use configured access on platform allowing athlete to access a list of names of previous purchasers of his or her licenses. Typically, for example where such athlete has policy of speaking only to prior purchasers, said athlete seeing request on platform for video conference is enabled to determine on platform if requestor is a former license purchaser.

In a preferred embodiment, instant invention does not rely on school name for any function of platform. In a preferred embodiment, instant invention does not rely on any team name for any function of platform. In a preferred embodiment, instant invention does not rely on any position designation such as quarterback or goalie or point guard for any function of platform. In a preferred embodiment, instant invention does not rely on any school-trademarked verbiage for any function of platform.

In a preferred embodiment, instant invention platform uses at least one notice advising avoidance by users of posting of sensitive personal data. In a preferred embodiment, said notice further advises platform-registered users not to trust everyone they meet online.

In a preferred embodiment, instant invention platform comprises fan-applied search referencing at least one high school student athlete at least by first letter of last name. In a preferred embodiment, instant invention platform comprises fan-applied search referencing county of student-athlete's high school.

In a preferred embodiment, instant invention platform comprises linked game show wherein fans of a first school sports team in a conference compete against fans of a second school sports team of said conference. Optionally, via the link between social media platform of platform-registered athlete and fans, the fans are alerted in reference to said contest schedule. Typically, such fans collect money to meet the entry fee, as further disclosed below.

In a preferred embodiment, in a fan-contest, each team places their entry fees into escrow with the emcee of the game show, such monies available to be awarded to winner of the contest. Typically, the questions relate to the spinning of the wheel of sport by contestant to select a question category, said category of questions typically about the rivalry between the two teams of the contestants, such as in school sports.

In a preferred embodiment, the fan contest is live cast to the athletes via instant invention online licensing platform video streaming link. In a preferred embodiment, a championship of fans is held at end of season, such as in timeframe matching the end of season sports tournament of the athletic teams of the conference. Such activity builds fan involvement and increases licensing sales via platform.

In a preferred embodiment, platform link comprises live streaming of sports event comprising view of game play of at least one platform-registered athlete. Live streaming is when the streamed video is sent over the Internet in real time, without first being recorded and stored. By transmitting a few seconds of the file at a time over the internet, client devices do not have to download the entire video before starting to play it.

In a preferred embodiment, said platform-supported sports event live streaming is configured using embed code, as well-known in the art. Said sports event live streaming is typically visible to platform-registrants, both fans and athletes. In a preferred embodiment, ads are live streamed during half-time of said live-streamed game. In a preferred embodiment, a portion of the income from displaying said ads are distributed to fans of winning team for further distribution at the fans' discretion, such as to buy name-licenses from student-athletes.

In a preferred embodiment, instant invention comprises an online licensing platform connecting a fan with an amateur athlete and providing for a conveyance of money to an amateur athlete contemporaneous to conveyance of licensing rights to a fan, said platform further:

allowing at least one amateur-status-protective pre-authorization notice to prospective amateur athlete registrant as sign-up process block requiring to continue that registering athlete first confirm reading of notice comprising wording seeking to reduce potential of loss of amateur eligibility, and
allowing choice of category for said registrant representation on platform as one of NIL-eligible college athlete and NIL-eligible high school athlete, and
allowing opportunity to view ratings input by other fans in reference to platform-registered athletes, and
allowing fans opportunity to request video conference with platform-registered athlete, and
allowing fan link to platform-registered athlete's social media posts, and
allowing fan opportunity to purchase on platform a license from said athlete, and
allowing fan opportunity to compete in test of knowledge of said athlete's sport as competition against other fans also registered on platform, and
allowing said athlete opportunity to view said fan competition via live stream link on said platform.

In a preferred embodiment, said online licensing platform further comprises progressive web application with instructions linked to home page for procedure applicable by user to place icon of said app on user's cell phone home page. In a preferred embodiment, said online licensing platform further comprises at least one URL for video on home page, said video referencing at least one student-athlete's lack of funds.

In a preferred embodiment, said online licensing platform further comprises platform-registered fan's access to live streaming link on platform wherein is visible to fan at least one sports game comprising sports game play of at least one athlete registered on platform. In a preferred embodiment said online licensing platform further comprises ad during live stream, said ad highlighting team members of a school team.

In a preferred embodiment, instant invention platform provides fans access to input on platform a rating for platform-registered student-athletes. For example, a fan can rate athlete as five stars for genuine identity, five stars for response to request for video conference, and five stars on quality of social media posts. Such ratings are visible for other fans. In this way, fans visiting site for first time can see other fan users' ratings of plurality of registered athletes. New fans can use such ratings to choose wisely and improve their enjoyment of site experience. In a preferred embodiment, the fan who spent more money on license purchases on platform earns a higher weight to his ratings display. In other words, the rating of high-purchasing fans is more influential mathematically in determining athlete rating than rating of low-purchasing fan.

### BRIEF DESCRIPTION OF FIGURES

Other features and advantages of the present invention will become apparent when the following detailed description is read in conjunction with the accompanying drawings, in which:

FIG. 1 is illustration of preferred embodiment web page.

FIG. 2 is illustration of preferred embodiment web page.

FIG. 3 is illustration of preferred embodiment web page.

FIG. 4 is illustration of preferred embodiment web page.

FIG. 5 is illustration of preferred embodiment web page.

FIG. 6 is schematic of preferred embodiment.

FIG. 7 is schematic of preferred embodiment.

FIG. 8 is schematic of preferred embodiment.

FIG. 9 is illustration of preferred embodiment web page.

FIG. 10 is illustration of preferred embodiment web page.

FIG. 11 is illustration of preferred embodiment.

### DETAILED DESCRIPTION OF THE DRAWINGS

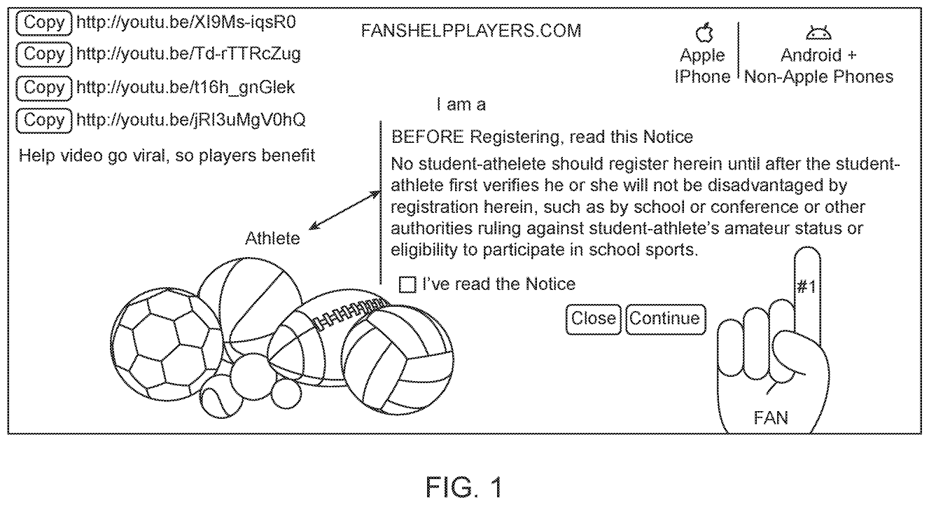

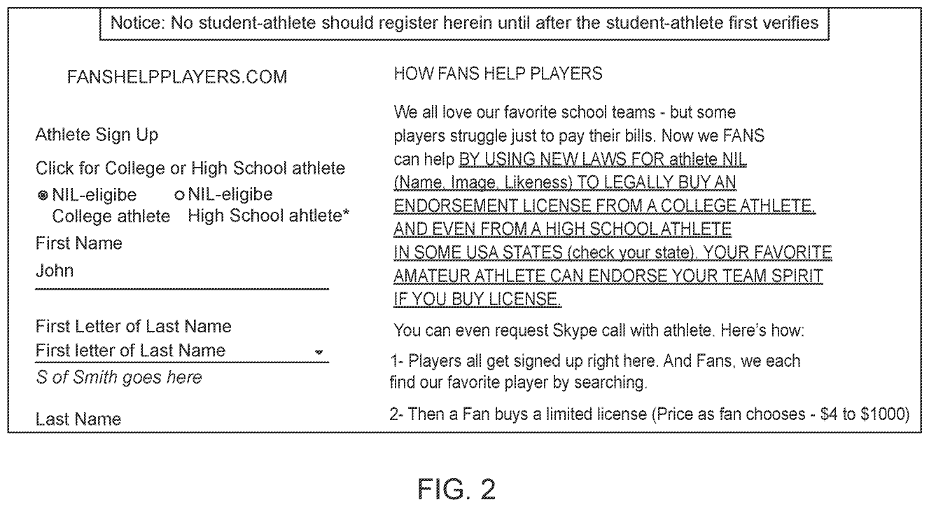

FIG. 1 is illustration of preferred embodiment web page illustrating a home page. On the home page at top left are URLs for videos explaining details of function of the online licensing platform, such as located on the linked YouTube channel of the site. Click on touch screen at location of URL causes video represented by said URL to play. At the top right are instructions for putting the icon of the progressive web app of the online licensing channel onto the cell phone home page of user. Following such instructions will allow at least many cell phone users to successfully place icon of website onto their home page of cell phone, thus allowing subsequent access to web site to be one button push on cell phone. In the middle part of the illustrated website home page are words ‘I am a’ and the associated two choices below that are ‘Athlete’ and ‘Fan’. In the circumstance where the person is visiting the home page to register as athlete on website, person clicks on the touch screen in the selection ‘Athlete’. Based on that click, the programming of the site displays the ‘BEFORE Registering’ pre-authorization block/Notice of information. Such block prevents user from proceeding to registration before responding to notice. Programming provides user opportunity to read the details of notice and then click to confirm he or she has read the notice. In a preferred embodiment, the words of the notice are: ‘Notice: No student-athlete should register herein until after the student-athlete first verifies he or she will not be disadvantaged by registration herein, such as by school or conference or other authorities ruling against student-athlete's amateur status or eligibility to participate in school sports.’ To continue in steps of registration, aspiring registrant must click on button signifying ‘I've read the notice,’ and then must click ‘Continue.’ Such response to block sequence allows aspiring registrant to see next registration sequence step, a field for selection, which is FIG. 2.

The notice-reading person can logically become more informed user. Such as informed student athlete who upon reading notice is thus alerted to potential risk of registering on the site if in violation of regulations applying specifically to said informed athlete reader. Such risk-awareness offers aspiring registrant an opportunity to wait to register if he or she has a question about which regulations apply to himself or herself. By clicking ‘close’, the user can then exit the site without registering. Such a user after exit can research his or her status to for a better understanding of his specific risk in selling name, image, and/or likeness licenses. Such rules and regulations can be in respect of the athlete's conference, state, and/or school as regards NIL activity of student athletes. By giving an aspiring registrant such block/notice opportunity to exit and research, the sequence of pre-authorization block/notice, and decision point of ‘close’ or ‘continue’, such opportunity can, at least in instance of amateur athlete who then discovers a conflict in regulations applicable to himself or herself, be amateur-status-protective.

FIG. 2 is illustration of preferred embodiment web page comprising continuation of sign-up process for athlete who has been informed of said potential risk by the FIG. 1 illustrated pre-authorization block/notification. In FIG. 2, located top-left of page is line ‘Athlete Sign-up’. Beneath said line are two choices for selection how registering person wishes to be represented to fans registered on site. The choice on left is: ‘NIL-eligible College Athlete’ and the choice adjacent is: ‘NIL-eligible High School Athlete’. This selection is coordinated to the FIG. 1 pre-authorization block/notification. In other words, for the registering person it amounts to first having knowledge of regulations applicable, then self-identifying to site as student athlete by clicking either of the FIG. 2 selections, i.e., ‘NIL-eligible College Athlete’ or ‘NIL-eligible High School Athlete’. Furthermore, said clicking selection of choice is made after said registering person has had at least opportunity to read the FIG. 1 notification, wherein risk self-assessment is recommended for registrant where said self-proclaimed athlete has any question about regulations applicable to self. Such post-notification option logically places responsibility onto registering person/student athlete to make the choice associated to honest representation of self to others on site and to safekeeping of his or her amateur status. Where registering athlete waits and inquires and discovers conflict in regulations applying to himself or herself, athlete could in good judgment delay or forego registration. Such inquiry could inform potential student athlete registrant as to his or her specific circumstances, such as rules of his or her school as pertaining to himself or herself regards pursuing NIL, and/or regulations of conference as pertaining NIL, and/or laws within state of his or her school's location, as pertaining to NIL. Such informed decision making, assisted by site, can preserve amateur status for such student athletes. Thus, the instant invention's use of pre-authorization block/notification and the associated use and wording of subsequent choices as ‘NIL-eligible’, these are steps which together are configured to be conducive to student athlete's good judgment being used in delaying registration until appropriate inquiry by athlete is made.

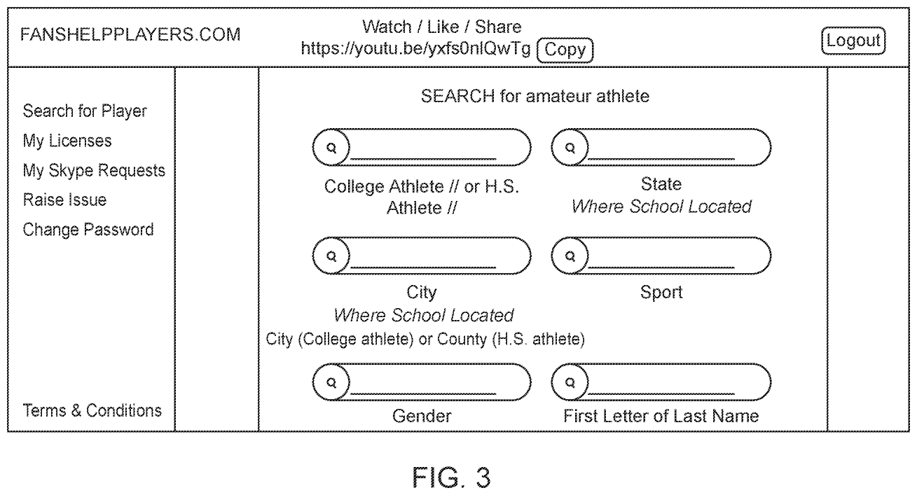

FIG. 3 is illustration of preferred embodiment web page which is configured to assist fans in their online search for registered student athletes, such search as when fan is seeking linked social media of athlete prior to fan deciding on potential purchase of license. In a preferred embodiment, such search page is presented to fans regarding database comprised of platform-registered thus self-proclaimed NIL-eligible student athletes. Such registered athletes are those who have gone through the two-step pre-authorization block/notification and NIL-eligible selection choices of FIGS. 1 and 2 as discussed above. In FIG. 3, under ‘SEARCH for amateur athlete’, the top left input field requires a choice of ‘college athlete’ or ‘H.S. athlete’. The ‘College Athlete’ choice requires the fan searcher to input the state and city of the college athlete's school. The high school athlete choice ‘H. S. Athlete’ requires the fan searcher to input the state and county where H.S. athlete's school is located. The college athlete choice is associated to a ‘State’ field choice from dropdown menu comprising the names of the 50 states of USA. This is because USA national rules (per recent Supreme Court decision in Alston, and acquiescence of NCAA and other regulatory groups) effectively allow college athletes nationwide to participate in NIL. By contrast, the high school athlete NIL eligibility question invokes each state's applicable law, and specific athlete's conference and school regulations. The dropdown menu of states for the ‘H.S. athlete’ choice is currently, at time of this writing, a list of 9 states, not 50. These 9 states are those which have enacted statutes, and in some cases amendments, specifically supporting high school athlete NIL participation. The 9 states are Alaska, California, Colorado, Kansas, Louisiana, Nebraska, New Jersey, New York, and Utah. At left side of FIG. 3 are listed the page designations available for fan to visit on site. Of note is the second on the list, ‘My licenses. This is listing of fan license purchases, as this fan has purchased from athletes registered on site. Further of note is fill in for locations are all filled from dropdown menus. The sport selection is clicked from dropdown list of sports. The gender selection is clicked from list of male and female. The first letter of last name is clicked from dropdown list of the 26 letters of the alphabet. Also, the City for college athlete, or county for high school athlete are respectively selected by search-designating fan from dropdown menus. The choice of college athlete or H.S. athlete is from dropdown menu. By avoiding any need for typing by search-designating fan, in fan's entering search specifications, and only requiring clicking fan to click from dropdown menus throughout, the likelihood of fan misspelling is reduced. Hence likelihood of correct inputs to search and find intended registered athlete is increased. The search results typically comprise all athletes of database who have matching data to entered specs, including matching first letter of last name. The search results are listed in alphabetical order. Searching fan can scroll down to find athlete they seek, again without need for fan to type in spelling of athlete name, only choices from dropdown menus including for first letter of athlete last name.

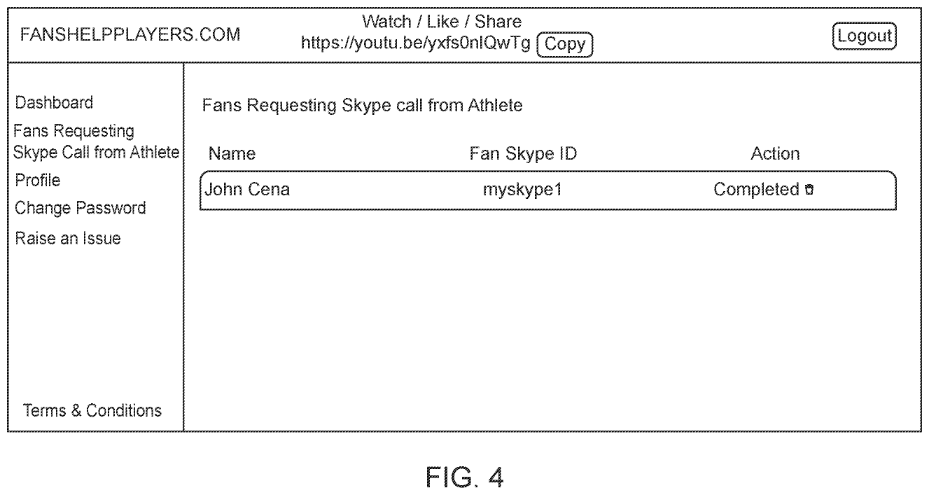

FIG. 4 is illustration of preferred embodiment web page illustrating page viewable by registered student athlete. This page comprises a list of fans requesting video conference call with athlete. The illustration FIG. 4 lists one fan whose name is listed as ‘John Cena’. This indicates John Cena is the name given at registration of fan who now is requesting video conference call at convenience of athlete. This list is a reference resource for the registered student athlete. Athlete can use this resource, such as for comparison to list of fans who have purchased license from said student athlete, as further discussed herein.

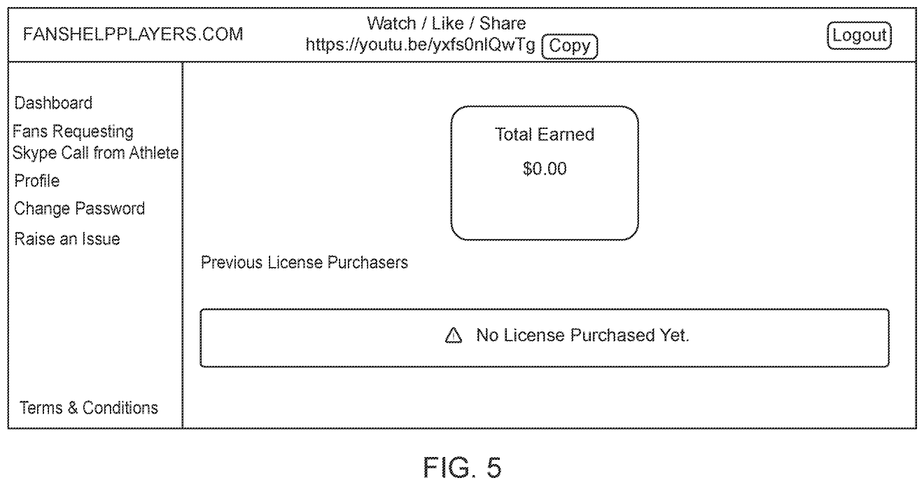

FIG. 5 is illustration of preferred embodiment web page viewable by platform-registered student athlete. On this page are registered fans on platform who have purchased license via platform in past from said page-viewing athlete. In the example illustrated in FIG. 5, indication is that no licenses have been purchased. Where FIG. 4 request for video conference with athlete by ‘John Cena’ is a simultaneous resource to the list of FIG. 5, then said athlete can conclude that none of his licenses have been purchased thus far by fan ‘John Cena’. Where said student athlete has a policy of not calling a videoconference-requesting fan unless said requesting fan is a previous buyer of said athlete's license on instant invention platform, then the fan John Cena would not receive a call from said page-viewing athlete at this time.

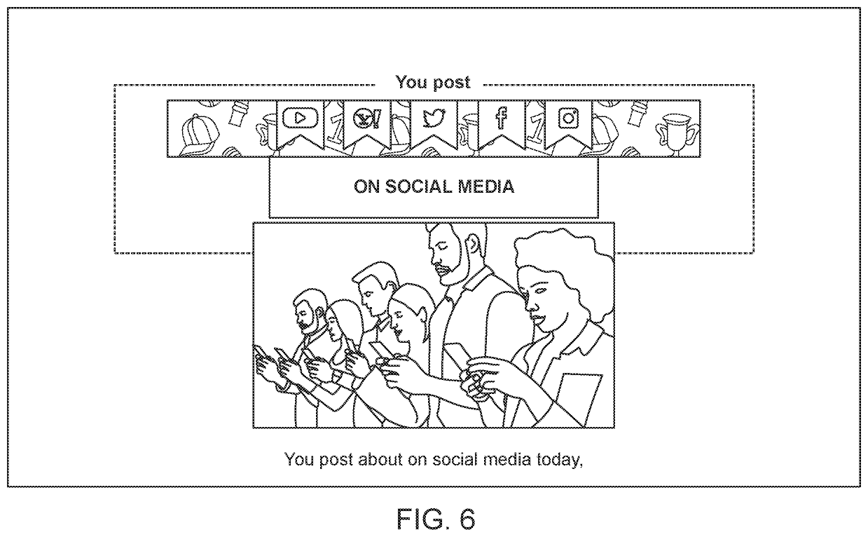

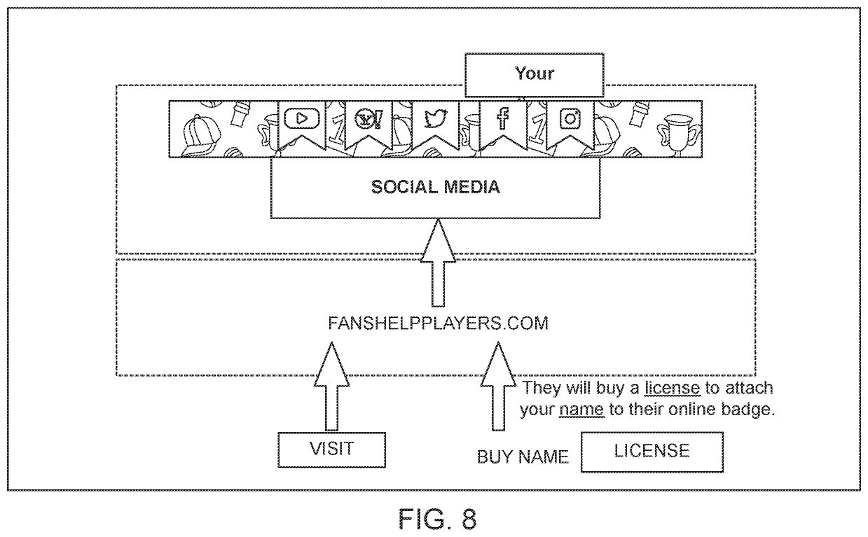

FIG. 6 is schematic of preferred embodiment wherein at bottom is illustrated a group of student athletes, each on their respective cell phone, each posting data on their respective social media regarding their sports experience at school sports. In FIG. 6, the schematic illustrates at top several icons of various well-known social media providers, such as Facebook, twitter, Instagram, and others. Such illustrated icons here represent the total universe of possible social media sites where platform-registered student athletes can post regarding their school sports goals and dreams and thinking. The words below the student athletes indicate recommendation by site to athletes that they post frequently, such as daily. Such frequent postings, viewable by fans, are considered likely to increase interest of fans, when fans access said posts (see FIG. 8), and likely to be associated to increase in license sales for said athlete.

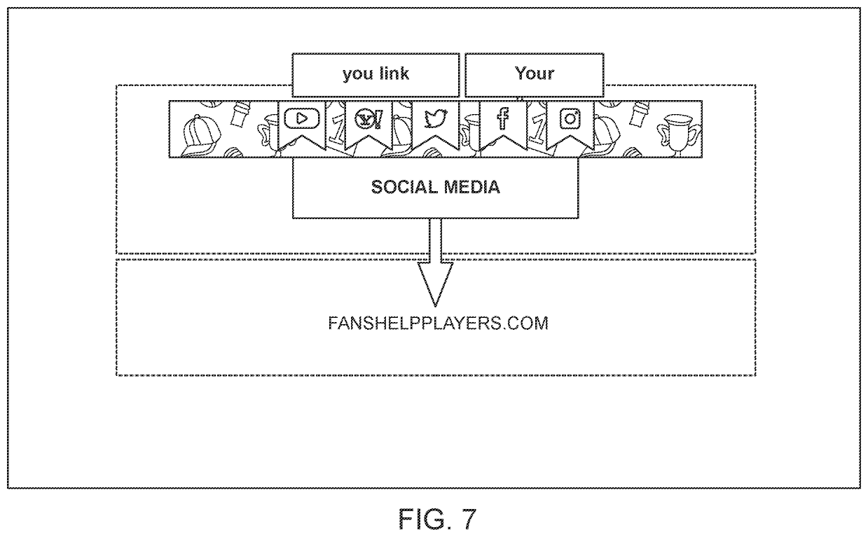

FIG. 7 is schematic of preferred embodiment in which the accounts comprising social media postings of student athletes of FIG. 6 are linked, by electronic link. to instant invention online licensing platform herein designated ‘FansHelpPlayers.com’. Such electronic link is configured within programming of instant invention as well known in the art. Thus, the online licensing platform allows plurality of fans visiting the said platform to each contemporaneously click-access a choice of social media postings of a plurality of student athletes.

FIG. 8 is schematic of preferred embodiment regarding FIG. 7 links of student athletes social media accounts comprising the platform-registered NIL-eligible student-athletes' sports-related posts. The link is shown by arrow in up direction by comparison to FIG. 7 down arrow direction, such up direction of arrow here taken to indicate visiting fans on online licensing platform are accessing data from said social media accounts of athletes. In FIG. 8, the visiting fans are each able to select on the platform among the registered student athletes' social media links. The visiting fan can thus make frequent, perhaps daily visits to platform. Fan can follow a selection of specific athletes as to their sports activities as reflected in athletes' daily postings. The visiting fan can decide he or she likes the attitude towards sports of one or more specific athletes, such as based on fan reading athlete's postings. Fan can use that decision, or liking attitude, to decide to buy a license from a specific athlete. In a preferred embodiment, said fan in viewing buy page (not shown) for purchase of a first athlete's name-license, can view on said buy page said first athlete's recommendations of ID #s of three other athletes (not shown). Said recommendations are a suggestion to the purchasing fan (not shown in FIG. 8), to review the social media posts of said recommended friend-athletes and consider purchase of license from each of said recommended friend-athletes.

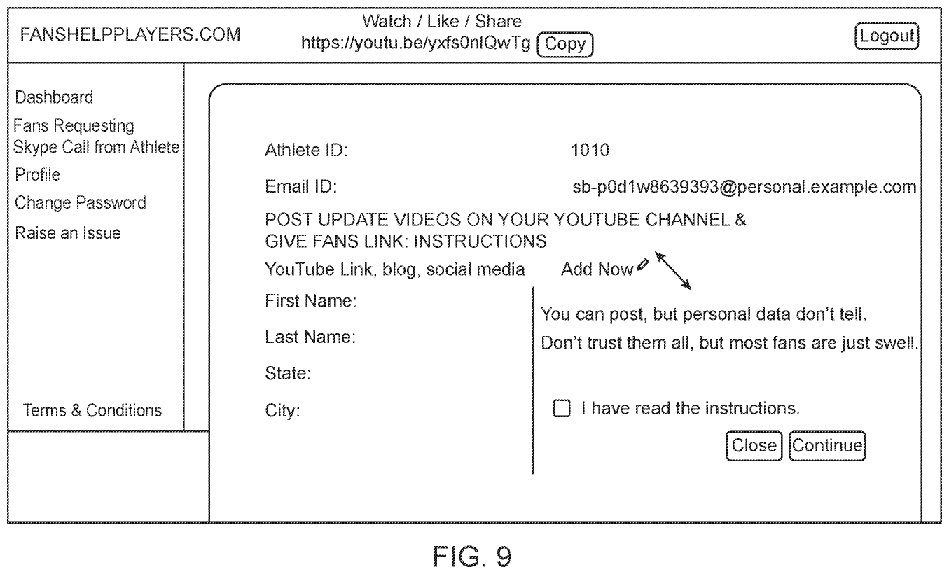

FIG. 9 is illustration of preferred embodiment web page wherein site programming assists registered athlete by block to athlete preparing to post link to his social media. This block operates to stop such link posting by athlete until athlete reads warning about personal data and trust. The block is activated when user clicks on the touch screen over word ‘instructions.’ The pop-up thus activated displays notice to user-athlete's view, providing a warning regarding inadvisability of online posting of sensitive personal data. The warning is typically displayed prior to registered student athlete posting link for his or her social media. Using the advice in the pre-authorization/pop-up notification, the student athlete will be more likely to avoid disclosing sensitive personal data in his or her online posts to online licensing platform fans. Thus athlete, assisted by site, potentially increases his or her personal safety. In a preferred embodiment, the notification is coordinated with a block requiring click to unblock, such click indicating user has read notice. Such notice further warns the student athlete, who as high school athlete might be as young as 14 years of age, against being too trusting regards persons athlete meets online.

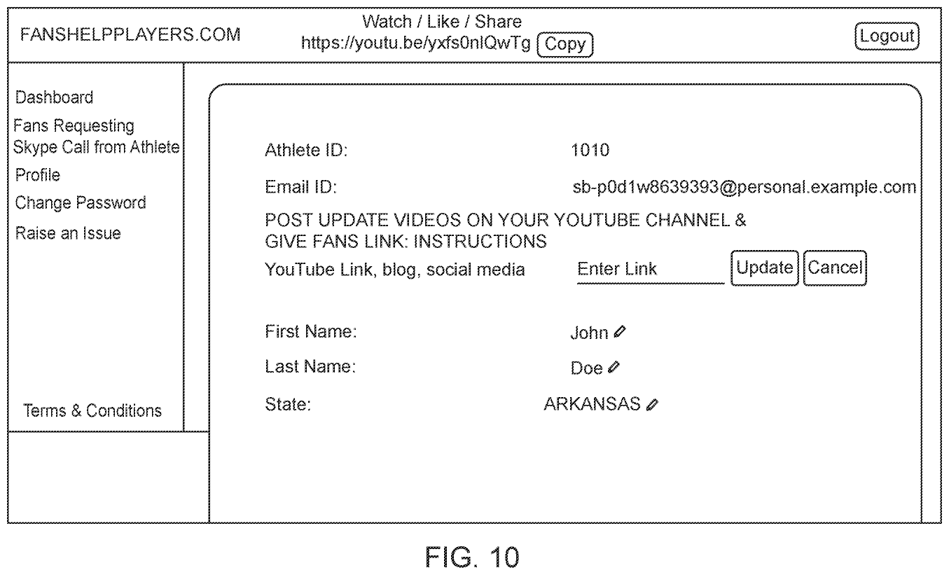

FIG. 10 is illustration of preferred embodiment web page wherein, after the reading of instructions of FIG. 9, student athlete clicked ‘continue’ and is allowed to provide link to his or her social media account at ‘enter link’ illustrated at middle of page. Such account is social media where athlete posts regarding his or her school sports activity. In FIG. 10, by following the said FIG. 9 advice, the link selected by student athlete to post said link will more likely comprise only postings which avoid sensitive personal data disclosure and avoid too trusting an attitude with persons encountered online.

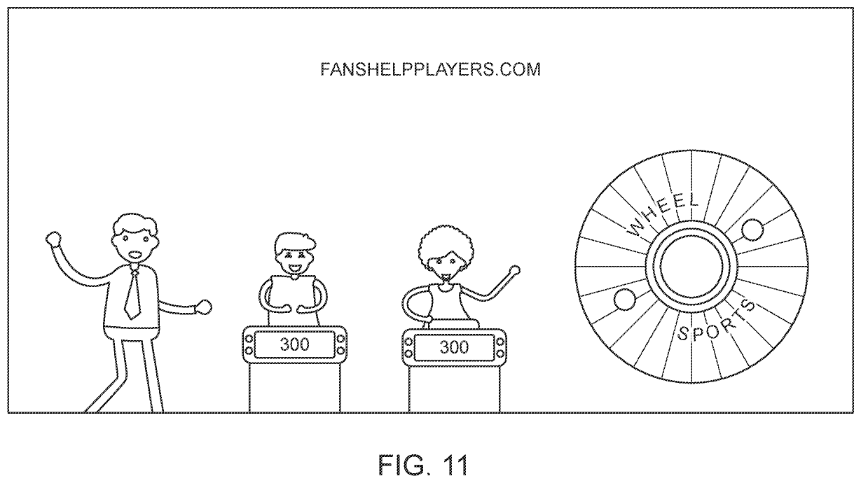

FIG. 11 is illustration of a preferred embodiment wherein a game show scene is live streamed for online licensing platform-registered fans and athletes. Technology allowing said live streaming typically comprises use of embed code, as is well known in the art. Such embed code is typically inserted into website code to allow for linking live streaming to site. Such technology is provided by several commercial providers, such as Dacast™. In the illustrated scenario of FIG. 11, the fan at the left podium represents a contestant playing contest for the athletes and fans of a first team. The fan at the right podium represents the opposing contestant playing contest for the athletes and fans of a second team. The emcee asks questions in categories as determined by wheel spin by contestant. The prize money in a preferred embodiment can comprise the combined entry fees of each first and second teams. Typically, the prize money is awarded to and spent by the fans of the contest-winning team. Winnings are typically used to purchase name-licenses of amateur athletes of that winning contestant's school sports team. The contest is optionally held for each sport during respective season, such as a series of football fan contests during football season, and a series of basketball fan contests during basketball season. In a preferred embodiment, a celebrity alumni contest is held at end of each season, such as at time of the final two sports teams of the conference playing on the field for the conference sports final. Typically, the above-described contests are live streamed via links of the instant invention platform to platform-registered fans and athletes. The alumni fan contests are typically held at the end of the school year with prize money contributed by corporate sponsors and winnings distributed to amateur athletes of winning school to buy name-licenses of platform-registered student-athletes of winning contestant's school from which winning-alumnus graduated.

Although the invention has been described in considerable detail in language specific to structural features, and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated and can be made without departing from the spirit and scope of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1. An online licensing platform comprising:
a local computer system configured to enable a fan to access said online licensing platform via the Internet, wherein said local computer system having computational hardware;
at least one notice viewable on said online licensing platform by at least one athlete having an amateur status, and wherein said computational hardware comprising a pre-authorization block configured to provide at least a temporary blocking of said athlete's online licensing platform use, and wherein said at least one notice comprising a warning to said at least one athlete to verify that said amateur status will not be disadvantaged by the use of said online licensing platform; and,
said online licensing platform configured to connect said fan with said at least one athlete such that a conveyance of money to said at least one athlete is configured to be transferred from said fan contemporaneous to conveyance of licensing rights to said fan.

2-3. (canceled)

4. The online platform of claim 1, further comprising use of in computational-hardware-enabled search to find registration data of said at least one athlete of a list comprising at least one of states, cities, and counties.

5. The online platform of claim 1, further comprising at least one recommendation by a first platform-registered athlete of at least one license of a second platform-registered athlete.

6. (canceled)

7. The online platform of claim 1, further comprising at least one image reference to athlete lack of funds.

8.-20. (canceled)
